(19) United States
(12) Patent Application Publication
(10) Pub. No.: US 2005/0223842 A1
(43) Pub. Date: Oct. 13, 2005

(54) Adjustable steering system

(76) Inventors: Joseph Dube, Northbridge, MA (US); John Oggiono, Upton, MA (US); Bogdan Zielinski, Worcester, MA (US)

Correspondence Address: Jenifer E. Haeckl, Esq.;Mirick, O'Connell, DeMallie & Lougee, LLP, 1700 West Park Drive, Westborough, MA, 01581, US

(21) Appl. No.: 10/822,070

(22) Filed: Apr. 9, 2004

(51) Int. Cl. B62K 21/12

(52) U.S. Cl. 74/551.1

(57) ABSTRACT

An adjustable steering system that is adapted for use with a vehicle having a steering stem, a steering stem angle, one or more fork members, and one or more handlebars, generally comprises: an upper triple clamp comprising, a first frame member comprising, one or more first fork member bores adapted to receive the fork member, one or more first steering stem bores adapted to receive the steering stem; one or more handlebar support members adapted to support the handlebar and provided with one or more modular stack members; and one or more bolt members to selectively maintain the handlebar support member in one or more selectable positions, wherein, the frame member has one or more frame engaging parts that are adapted to engage, at the selectable positions, one or more handlebar support engaging parts provided on the handlebar support member; and one or more steering angle members to selectively change the angle of the steering stem; and a lower triple clamp comprising, a second frame member comprising, one or more second fork member bores adapted to receive the fork member, one or more second steering stem bores adapted to receive the steering stem; one or more steering angle members to selectively change the angle of the steering stem.

### FIELD OF THE INVENTION

This invention relates to vehicles that utilize a steering stem and handlebars and more specifically to a unique triple clamp and system that allows the user to readily adjust the position or position of the steering stem and handlebars to suit the user's needs.

### BACKGROUND OF THE INVENTION

Triple clamps are well known means for securing both the handlebars and the steering stem of a motorcycle or similar vehicle to the steering frame. Currently, such steering stems are secured in a single fixed position and angle that is generally along a y-axis substantially perpendicular to the ground or in a vertical position relative to the substantially horizontal position of the triple clamp. The handlebars are also typically secured in a single fixed position and angle that is generally along an x-axis substantially parallel to the ground or to the substantially horizontal position of the triple clamp. See, for example, U.S. Pat. No. 6,176,339 to Reichardt. To date, there is little accommodation for different body types and sizes among riders. Rather, such vehicles are designed for the “average” rider and anyone who is not average must compensate by adjusting their body position relative to the vehicle. Such compensation increases the physical stress on the rider and in general decreases the rider's control over the vehicle.

For example, motocross racing for motorcycles or bicycles involves a varied and rough terrain. Constant tensile and compression loads associated with such racing cause tremendous stress on a rider's body that is compounded when the handlebars are not at an optimum position and angle for the given rider.

Typically, individuals must order custom made triple clamps in which the bores or apertures through the triple clamps for the handle bars and steering stems are formed or machined in non-standard positions according to the particular individual's desired specifications. However, as with any customized product, and particularly with a product that is cast or machined, the cost of such customization is oftentimes cost prohibitive. In addition, the individual is not able to test whether a specification location for the bores or apertures will be optimum until after the custom made triple clamp is finished.

There have been a couple of attempts to address these ergonomic issues, in view of the expense of customized triple clamps. The first type is an aftermarket triple clamp that provides two to four preset handlebar horizontal positions rather than just one. However, this alternative is limited to four positions at most and is unwieldy and not readily adjusted. The second type of aftermarket triple clamp provides one preset forward handlebar position and four present rearward handlebar positions. Similarly this alternative is limited to the extent that it offers only one forward position. The second type is also unstable. It is unstable because it relies on an insufficient mechanism for fixing the handlebar in a given position. Specifically, the second type relies on a mechanism that consists of a single bolt that passes through a single bore through the triple clamp and is tightened down to the flat underside of the clamp with a standard nut. This type of mechanism is wholly insufficient because it allows the handlebar unit to rotate and to move out of position when the nut becomes loosened which is common for this type of clamp.

As for the need for an adjustable steering stem, to date there are no stock or aftermarket triple clamps that provide alternative steering stem positions or angles.

### SUMMARY OF THE INVENTION

It is therefore an object of the invention to provide an adjustable steering system for a vehicle, such as a motorcycle, that allows a person to adjust the horizontal or vertical position of the handlebars or the angle of the steering stem.

It is another object of the invention to provide an affordable means for adjusting the position or angle of one or more aspects of the steering system of a vehicle to accommodate varying sizes and steering position preferences of riders without the need for expensive customized parts.

A preferred embodiment of the triple clamp of the invention that is adapted for use with a vehicle having a steering stem, one or more fork members, and one or more handlebars, generally comprises: a frame member having a perimeter comprising a front edge, a back edge and having a centerline between the front edge and the back edge, comprising, one or more fork member bores adapted to receive the fork member, one or more steering stem bores adapted to receive the steering stem; one or more handlebar support members adapted to support the handlebar; and one or more means to selectively maintain the handlebar support member in one or more selectable positions; wherein, the frame member has one or more frame engaging parts that are adapted to engage, at the selectable positions, one or more handlebar support engaging parts provided on the handlebar support member, and wherein at least two of the selectable positions are between the front edge and the centerline, and at least two of the selectable positions are between the back edge and the centerline.

At least one of the means to selectively maintain the handlebar support member may comprise two or more bolts that are each adapted to pass through bolt bores provided in the handlebar support member and the frame member; and the frame member having an underside with an outer surface may further comprise a recess in the underside into which at least a portion of the bolts is adapted to protrude from the bolt bores and to engage one or more corresponding stabilizing members having an outer surface that is flush with or within the recess below the outer surface of the frame member.

The bolts preferably have threads, wherein the stabilizing member also preferably comprises two or more threaded bores corresponding to threads on the bolts.

The handlebar support members have a perimeter that preferably remains within the perimeter of the frame member when the handlebar support members are positioned at any one or more of the selectable positions. In addition, the triple clamp may further comprise one or more position indicators.

Another preferred embodiment of the triple clamp of the invention that is adapted for use with a vehicle having a steering stem, one or more fork members, and one or more handlebars, comprising, a frame member, comprising, one or more fork member bores adapted to receive fork member, one or more steering stem bores adapted to receive the steering stem; one or more handlebar support members adapted to support the handlebar; and one or more means, to selectively maintain the handlebar support member in one or more of the selectable positions, comprising, two or more bolts each adapted to pass through bolt bores provided in the handlebar support member and the frame member; wherein, the frame member has one or more frame engaging parts adapted to engage, at selectable positions, one or more handlebar support engaging parts provided on the handlebar support member. The frame member typically has an underside with an outer surface and may further comprise a recess in the underside into which at least a portion of the bolts are adapted to protrude from the bolt bores and to engage one or more corresponding stabilizing members having an outer surface that is flush with or within the recess below the outer surface of the frame member; and may further comprise one or more position indicators.

Another preferred embodiment of the triple clamp of the invention that adapted for use with a vehicle having a steering stem, steering stem angle, and one or more fork members, generally comprises: a frame member comprising, one or more fork member bores adapted to receive the fork member, one or more steering stem bores adapted to receive the steering stem; and one or more means to selectively change the angle of the steering stem; wherein one or more of the means to selectively change the angle of the steering stem may comprise, an inset member, having an offset bore through the inset member adapted to receive the steering stem, that is adapted to be inset in the steering stem bore. The steering angle member, such as an inset member, is preferably adapted to provide two or more selectable steering stem angles; and is preferably adapted to be removably fixed in the frame member.

Typically, the frame member has an outer surface and the inset member has an outer surface that, while the inset member is inset in the steering stem bore, is flush with or within the steering stem bore below the outer surface of the frame member.

The vehicle may further comprise one or more handlebars, in which instance, the triple clamp preferably further comprises: one or more handlebar support members adapted to support the handlebar; and one or more means to selectively maintain the handlebar support member in one or more selectable positions; wherein one or more of the means to selectively maintain the handlebar support member may comprise; one or more frame engaging parts that are adapted to engage, at the selectable positions, one or more handlebar support engaging parts provided on the handlebar support member.

A preferred embodiment of the adjustable steering system of the invention that adapted for use with a vehicle having a steering stem, a steering stem angle, one or more fork members, and one or more handlebars, generally comprises: an upper triple clamp comprising, a first frame member comprising, one or more fork member bores adapted to receive the fork member, one or more steering stem bores adapted to receive the steering stem; one or more handlebar support members adapted to support the handlebar; and one or more means to selectively maintain the handlebar support member in one or more selectable positions, wherein, the frame member has one or more frame engaging parts that are adapted to engage, at the selectable positions, one or more handlebar support engaging parts provided on the handlebar support member; and a lower triple clamp comprising, a second frame member comprising, one or more fork member bores adapted to receive the fork member, one or more steering stem bores adapted to receive the steering stem; one or more means to selectively change the angle of the steering stem.

One or more of the means to selectively change the angle of the steering stem of the system preferably comprises, a steering angle member, having an offset bore through the steering angle member adapted to receive the steering stem, that is adapted to be removably fixed in the steering stem bore of the second frame member.

The means to selectively change the angle of the steering stem preferably comprises a steering angle device, adapted for use with a triple clamp of a vehicle having a steering stem and a steering stem angle, wherein the triple clamp has one or more steering stem bores adapted to receive the steering stem at an angle relative to the triple clamp and one or more steering angle apertures; the steering angle device comprising, a steering angle frame having a perimeter with two perimeter points located on the perimeter opposite from one another, and a frame centerpoint that is equidistant from the two opposite perimeter points, wherein the steering angle frame has a bore, that is adapted to receive the steering stem through the bore, wherein the bore has a bore centerpoint that is offset from the frame centerpoint, and wherein at least a portion of the steering angle frame is adapted to be removably fixed in the steering angle aperture.

The frame member system typically has a front edge, a back edge and a centerline between the front edge and the back edge; wherein at least two of the selectable positions are between the front edge and the centerline, and at least two of the selectable positions are between the back edge and the centerline.

At least one of the system's means to selectively maintain the handlebar support member may comprise two or more bolts that are each adapted to pass through bolt bores provided in the handlebar support member and the frame member; and wherein the frame member has an underside with an outer surface and further comprises a recess in the underside into which at least a portion of the bolts is adapted to protrude from the bolt bores and to engage one or more corresponding stabilizing members having an outer surface that is flush with or within the recess below the outer surface of the frame member.

The first frame member of the upper triple clamp may further comprise one or more means to selectively change the angle of the steering stem; wherein one or more of the means, of the first frame member, to selectively change the angle of the steering stem may comprise, an inset member, having an offset bore through the inset member adapted to receive the steering stem, that is adapted to be inset in the steering stem bore of the second frame member.

Another preferred embodiment of the adjustable steering system of the invention that is adapted for use with a vehicle having a steering stem, a steering stem angle, one or more fork members, and one or more handlebars, generally comprises: an upper triple clamp comprising, a first frame member comprising, one or more first fork member bores adapted to receive the fork member, one or more first steering stem bores adapted to receive the steering stem; one or more handlebar support members adapted to support the handlebar; and one or more means to selectively maintain the handlebar support member in one or more selectable positions, wherein, the frame member has one or more frame engaging parts that are adapted to engage, at the selectable positions, one or more handlebar support engaging parts provided on the handlebar support member; and one or more first means to selectively change the angle of the steering stem; and a lower triple clamp comprising, a second frame member comprising, one or more second fork member bores adapted to receive the fork member, one or more second steering stem bores adapted to receive the steering stem; one or more second means to selectively change the angle of the steering stem.

One or more of the first means or the second means, to selectively change the angle of the steering stem, preferably comprises, an inset member, having an offset bore through the inset member that is adapted to receive the steering stem, that is adapted to be inset in the first or second steering stem bore, respectively.

Another preferred embodiment of the adjustable steering system of the invention that is adapted for use with a vehicle having a steering stem, a steering stem angle, one or more fork members, and one or more handlebars, generally comprises: an upper triple clamp comprising, a first frame member comprising, one or more first fork member bores adapted to receive the fork member, one or more first steering stem bores adapted to receive the steering stem; one or more handlebar support members adapted to support the handlebar; and one or more means to selectively maintain the handlebar support member in one or more selectable positions, wherein, the frame member has one or more frame engaging parts that are adapted to engage, at the selectable positions, one or more handlebar support engaging parts provided on the handlebar support member; and one or more first means to selectively change the angle of the steering stem; and a lower triple clamp comprising, a second frame member comprising, one or more second fork member bores adapted to receive the fork member, one or more second steering stem bores adapted to receive the steering stem; one or more means to selectively change the angle of the steering stem.

Another preferred embodiment of the triple clamp of the invention that is adapted for use with a vehicle having a steering stem, one or more fork members, and one or more handlebars set at a height, generally comprises: a frame member comprising, one or more fork member bores adapted to receive the fork member, one or more steering stem bores adapted to receive the steering stem; one or more handlebar support members adapted to support the handlebar; and one or more means to selectively maintain the handlebar support member in one or more selectable positions; wherein the handlebar support member comprises one or more modular stack members that are adapted to selectively vary the height of the handlebar.

Another preferred embodiment of the adjustable steering system of the invention that is adapted for use with a vehicle having a steering stem, a steering stem angle, one or more fork members, and one or more handlebars, generally comprises: an upper triple clamp comprising, a first frame member comprising, one or more first fork member bores adapted to receive the fork member, one or more first steering stem bores adapted to receive the steering stem; one or more handlebar support members adapted to support the handlebar; and one or more means to selectively maintain the handlebar support member in one or more selectable positions, wherein, the frame member has one or more frame engaging parts that are adapted to engage, at the selectable positions, one or more handlebar support engaging parts provided on the handlebar support member; one or more first means to selectively change the angle of the steering stem; and a lower triple clamp comprising, a second frame member comprising, one or more second fork member bores adapted to receive the fork member, one or more second steering stem bores adapted to receive the steering stem; one or more means to selectively change the angle of the steering stem; and wherein the handlebar support member comprises one or more modular stack members that are adapted to selectively vary the height of the handlebar.

### BRIEF DESCRIPTION OF THE DRAWINGS

Other objects, features and advantages will occur to those skilled in the art from the following description of the preferred embodiments and the accompanying drawings in which:

FIG. 1A is a bottom view of a preferred embodiment of the frame member of the upper triple clamp of the invention with an inset member inset in the steering stem bore of the frame member;

FIG. 1B is a side view of the embodiment of the frame member shown in FIG. 1A;

FIG. 1C is a top view of the embodiment of the frame member shown in FIG. 1A;

FIG. 2A is a top view of a preferred embodiment of the handlebar support member of the invention;

FIG. 2B is a side view of the embodiment of the handlebar support member shown in FIG. 2A;

FIG. 2C is a bottom view of the embodiment of the handlebar support member shown in FIG. 2A;

FIG. 3A is a bottom view of a preferred embodiment of the frame member of the lower triple clamp of the invention;

FIG. 3B is a side view of the embodiment of the frame member shown in FIG. 3A;

FIG. 3C is a top view of the embodiment of the frame member shown in FIG. 3A;

FIG. 4 includes three top views of preferred embodiments of the steering angle member of the upper triple clamp of the invention illustrating the offset bore through the steering angle member;

FIG. 5 includes three top views of preferred embodiments of the steering angle member of the lower triple clamp of the invention illustrating the offset bore through the steering angle member;

FIG. 6A is a top view of another preferred embodiment of the handlebar support member comprising a plurality of modular stack members;

FIG. 6B is a side view of the preferred embodiment of the handlebar support member of FIG. 6A;

FIG. 6C is a bottom view of the preferred embodiment of the handlebar support member of FIG. 6A, and

FIG. 7 is a top view of another embodiment of the steering angle member of the invention.

### DETAILED DESCRIPTION OF THE PREFERRED EMBODIMENTS

The invention features novel adjustable steering systems, triple clamps, and interchangeable triple clamp components that enable a person to readily change and adjust the vertical and horizontal positions and angles of a vehicle's steering mechanism. The triple clamps and components of the invention are particularly suited for, but not necessarily limited to, use as part of a motorcycle or any other vehicle which utilizes a steering stem, shaft or column held in a rotatable position relative to one or more frame members such as, but not limited to, bicycles, snowmobiles or jet skis. When referring to vertical or horizontal positions of the steering stem and handbars, these terms are not limited to positions that are exactly 90 degrees or 180 degrees, respectively, relative to the ground or to each other. For example, most steering stems of vehicles are set at an angle that is less than 90 degrees when viewed from the side because drivers sit behind the steering system and relatively low to the ground so that the center of gravity of the vehicle and driver are low to the ground.

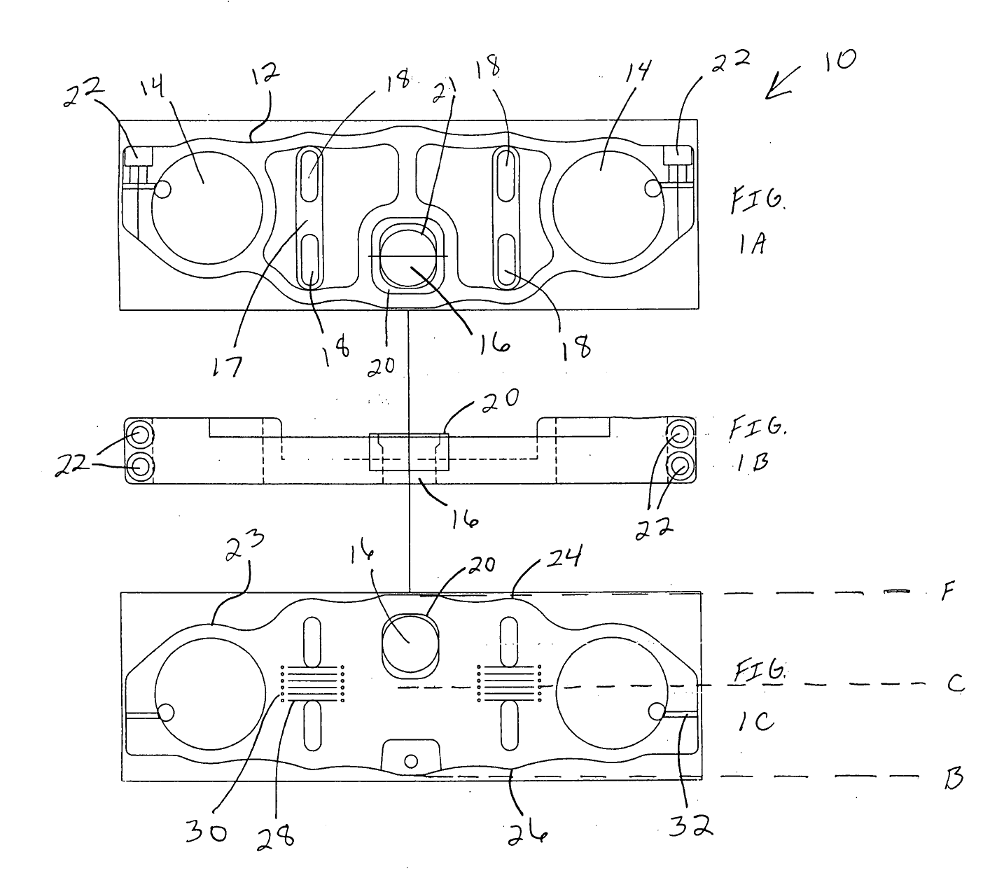

FIGS. 1A-1C show a preferred embodiment of the frame member, preferably used in an upper triple clamp, generally referred to as frame member 10. Frame 10 may be cast or machined out of a variety of materials and may be coated. Although the material selected will depend on the vehicle with which the frame will be used and such materials are known to those skilled in the art, frame 10 may be machined out of a solid billet of 6061T6 aluminum and may include an anodized coating.

Frame member 10 has two fork member bores 14 and one steering stem bore 16. The fork member bores must be of sufficient size and shape to allow a fork member (not shown) to pass through the bore. Front forks are known in the art and are utilized in vehicles such as motorcycles, bicycles, snowmobiles and jet skis, and other similar vehicles, to connect the steering mechanism, including the front axle to the main frame of the vehicle or other similar types of vehicles that utilize forks to attach the steering system to the front portion of the vehicle. For example, front fork, or, alternatively, shock absorber or “forked suspension” are described in U.S. Pat. No. 6,371,263 to Hoose and U.S. Pat. No. 6,244,609 to Wilson, or a combination, any type of support frame members

Once the forks are passed through bores 14, four bolts are threaded through holes 22 to tighten the opening to firmly fix frame 10 onto the front fort. Slots 32 may be provided to allow for some give and variability in size associated with forks. Steering stem bore 16 must likewise be of sufficient size and shape to allow a steering stem member (not shown) to pass through the bore.

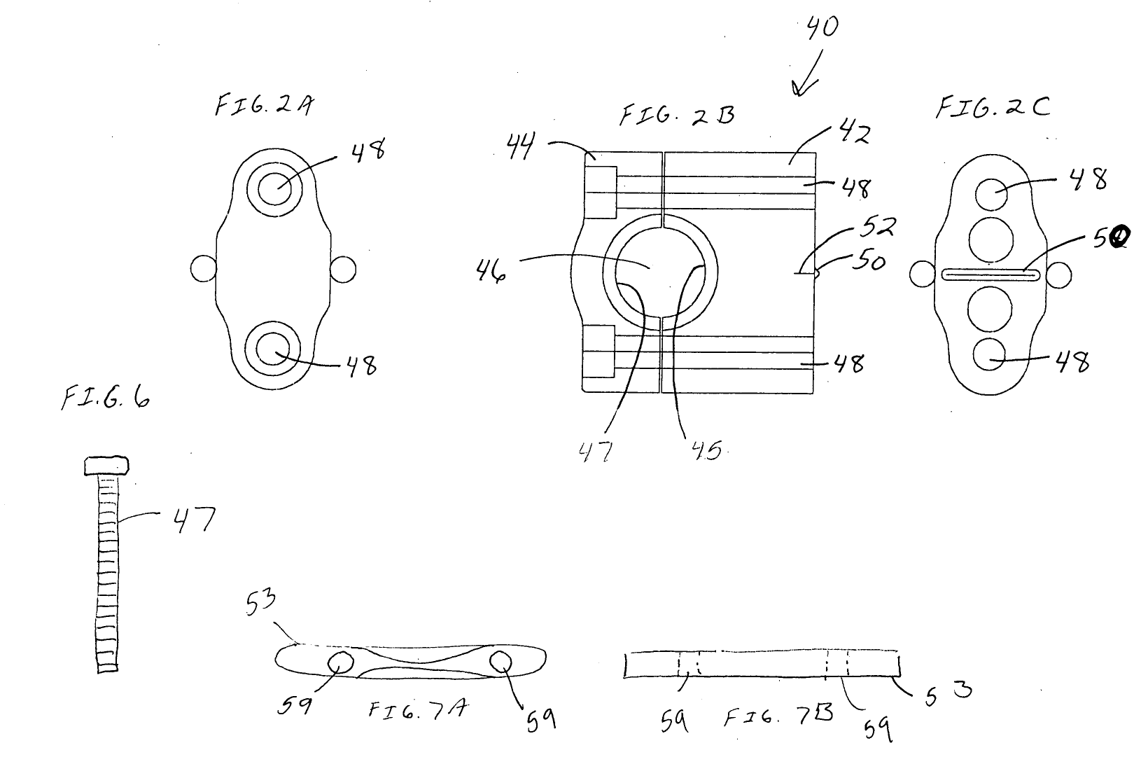

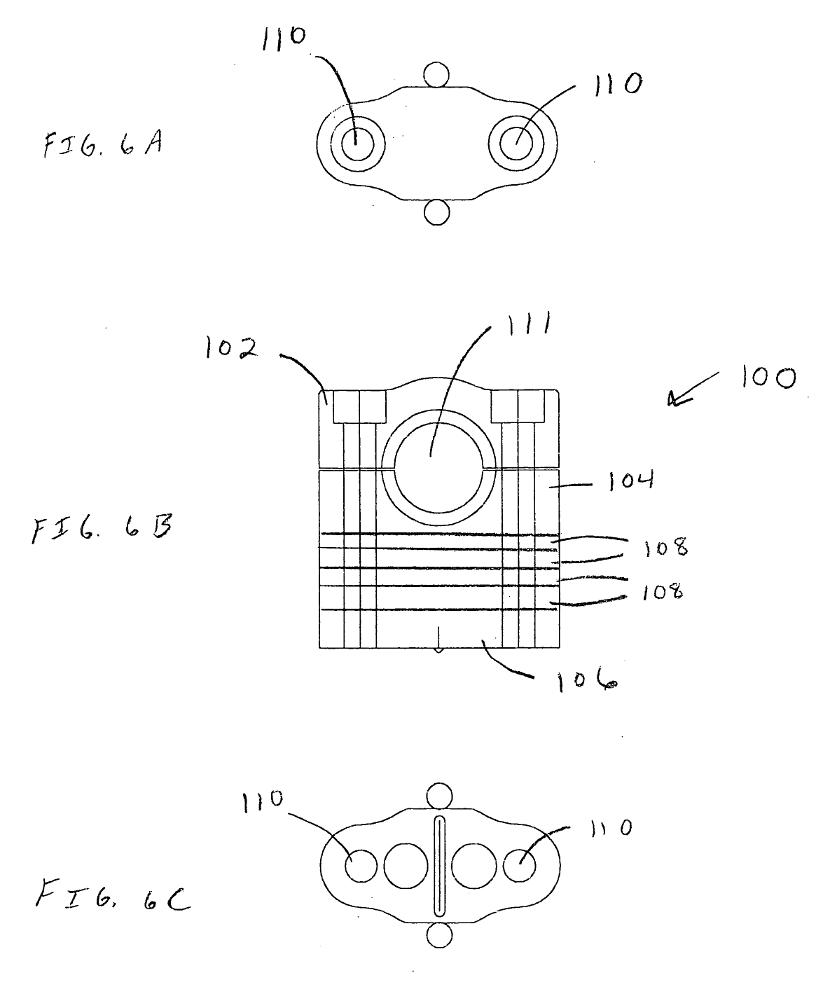

Frame member 10 also has four bolt bores 18 which must be of sufficient size to allow a bolt 47 (FIG. 6) to pass through the bore. Bolt 47 is used to maintain the two handlebar support members 40, one of which is shown in FIGS. 2A-2C, in place on frame 10. Handlebar support member 40 preferably comprises an upper part 44 and a corresponding lower part 42, each part having a semi-annular edge, (47 and 45, respectively), that, when the two parts are fitted together, form an annular aperture 46 through which the handlebar (not shown) is secured. The handlebar support member is then placed on the upper side of frame 10 and bolts 47 are passed through bolt bores 48 provided through both halves of the handlebar support member.

The triple clamp may also comprise a plurality of frame engaging parts (e.g. v-grooves 28, FIG. 1C) that are adapted to selectively engage a handlebar support engage part (e.g. detent 50, FIG. 2B). For example, frame 10 has two sets of v-grooves 28 and two corresponding sets of indicators 30 on the upper side of frame 10. Tongue 50, provided on the bottom of the lower part 42 of handlebar support member 40, is adapted to fit within any one of v-grooves 28. Which groove is selected will depend upon the user. There are no specific limitations on the number of engaging parts provided on the frame member or the handlebar support member. The number of engaging parts provided will depend on the amount of adjustability desired, however, to enable the user to move the handlebar forward or backward from the typical centerline C (FIG. 1C), there are preferably at least two selectable positions between front edge F and centerline C and at least two selectable positions between centerline C and back edge B.

In this embodiment, each v-groove represents a selectable position. However, the v-grooves could be provided on the handlebar support member and the tongue could correspondingly be provided on the frame member. In addition, the engaging parts are not limited to a tongue and groove design, and may include, but are not limited to, other types of apertures or bores with corresponding detents, dowels, bolts or screws.

Indicators 30 also may take any number of varied forms. In frame 10, indicators 30 are small depressions provided beyond the periphery of handlebar support member 40, when member 40 is fixed in place. There is also an indicator line 52 on the side handlebar support member 40 that corresponds to the location of tongue 50. A user may select a position by lining up indicator line 52 with an indicator depression and then fix one of the handlebar support members 40 in place with bolts 47. Then, based on the indicated position of the first handlebar support member 40, the second handlebar support member 40 can be placed into an identical position over the second set of v-grooves on frame 10 so that the handlebar is square to the frame.

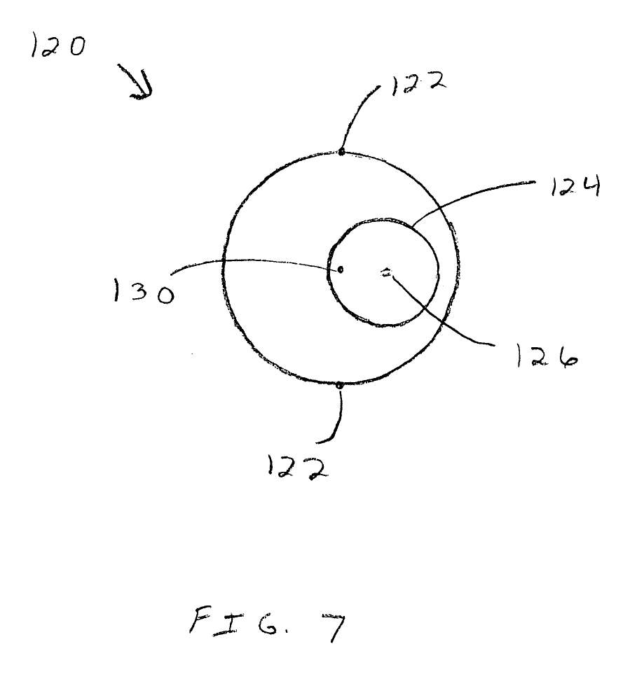

Stabilizing members 53, shown in FIGS. 7A and 7B, are also preferably provided with the frame member as part of the upper triple clamp. Each stabilizing member is adapted to fit inside a recess 17 in the underside of frame 10. Two stabilizing bores 59 through each stabilizing member must be of sufficient size and shape to allow bolts 48 to pass through. The stabilizing members further act to stabilize the handlebar support members and thus, the handlebar itself to keep the handlebar support members from shifting out of the selected position or from otherwise moving in any direction out of place. When the stabilizing members are seated in their respective recess, the outer surface of the stabilizing members preferably is flush with or below the outer surface of the underside of the frame member.

Frame 10 has a periphery 12 that is shown in this embodiment as somewhat irregular in shape. However the shape of the frame member is not limited to that shown in the drawings or as described in the embodiment. The periphery refers to the outer edge of the upper side of the frame member. When the handlebar support member is fixed in any one of the selected positions, the handlebar support member preferably does not extend beyond the periphery or outer edge of the upper side of the frame member. The entire triple clamp preferably has as smooth a profile as possible to cut down on drag and to provide a safer and more aesthetic surface.

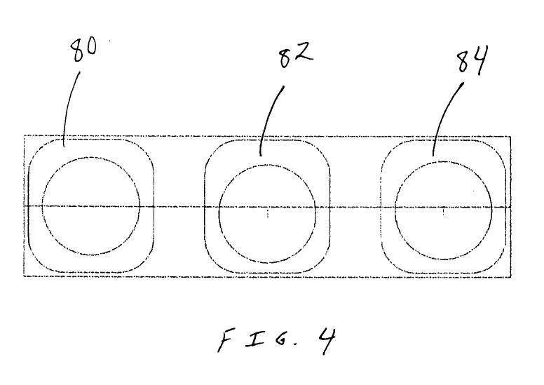

The triple clamp may also be provided with a steering angle member or device that is a means to selectively change the angle of the steering stem such as inset member 20. Similar to frame 10, steering angle member can be made from any number of suitable materials and coated and may be fixed in position in steering stem bore 16 simply by friction or any other fixation means suitable to the rigors of vehicular use including, but not limited to, threads, ratchets, bolts, detents, and latches. For example, frame 10 is provided with an inset member 20 that is adapted to seat snugly in steering stem bore or aperture 16 before the steering stem is passed through bore 16. Offset bore 21 is provided in inset member 20 to enable the user to adjust the angle of the steering stem (not shown). The user may adjust the angle by repositioning inset member 20 into bore 16. Since bore 21 is offset, at least three possible angle positions, as shown in FIG. 4, are available for selection. For example, a first angle is shown as position 80, a second angle is shown as position 82, and a third angle is shown as position 84. The angle selected depends on the orientation of inset 20 when placed in steering stem bore 16. Any number of, and variation on, inset member 20 may be interchangeably used with frame 10 and is not limited to the design and generally square shape of inset member 20 shown and described in this specification. When seated in the steering stem bore, the outer surface of the inset member is also preferably flush with or below the outer surface of the upper side of the frame member.

The shape and design of the steering angle member is not necessarily limited to an inset member that fits snugly into a corresponding bore. The only limiting shape and size of steering angle member is the shape of the bore through which the steering stem is passed, specifically, which must allow the steering stem to rotate freely within the bore. For example, as shown in FIG. 7, the steering angle member may comprise a round frame 120 having a perimeter 128 with perimeter points 122 opposite from one another that define a steering angle frame centerpoint 130, and having an offset bore 124 having a bore centerpoint 126, wherein the outside surface of the round frame is threaded and steering stem bore 16 is provided with corresponding threads so that the steering angle member may be repositioned, or replaced with another steering angle member, and then screwed into a correspondingly threaded bore 16. As another example, the steering angle member may be rectangular or cross-shaped with one or more bores, offset from two opposing perimeter points for repositioning the steering stem, and one or more bores adapted to receive a screw or bolt to fix the steering angle member in place in frame 10.

The means to selectively change the angle of the steering stem preferably comprises a steering angle device, adapted for use with a triple clamp of a vehicle having a steering stem and a steering stem angle, wherein the triple clamp has one or more steering stem bores adapted to receive the steering stem at an angle relative to the triple clamp and one or more steering angle apertures; the steering angle device comprising, a steering angle frame having a perimeter with two perimeter points located on the perimeter opposite from one another, and a frame centerpoint that is equidistant from the two opposite perimeter points, wherein the steering angle frame has a bore, that is adapted to receive the steering stem through the bore, wherein the bore has a bore centerpoint that is offset from the frame centerpoint, and wherein at least a portion of the steering angle frame is adapted to be removably fixed in the steering angle aperture.

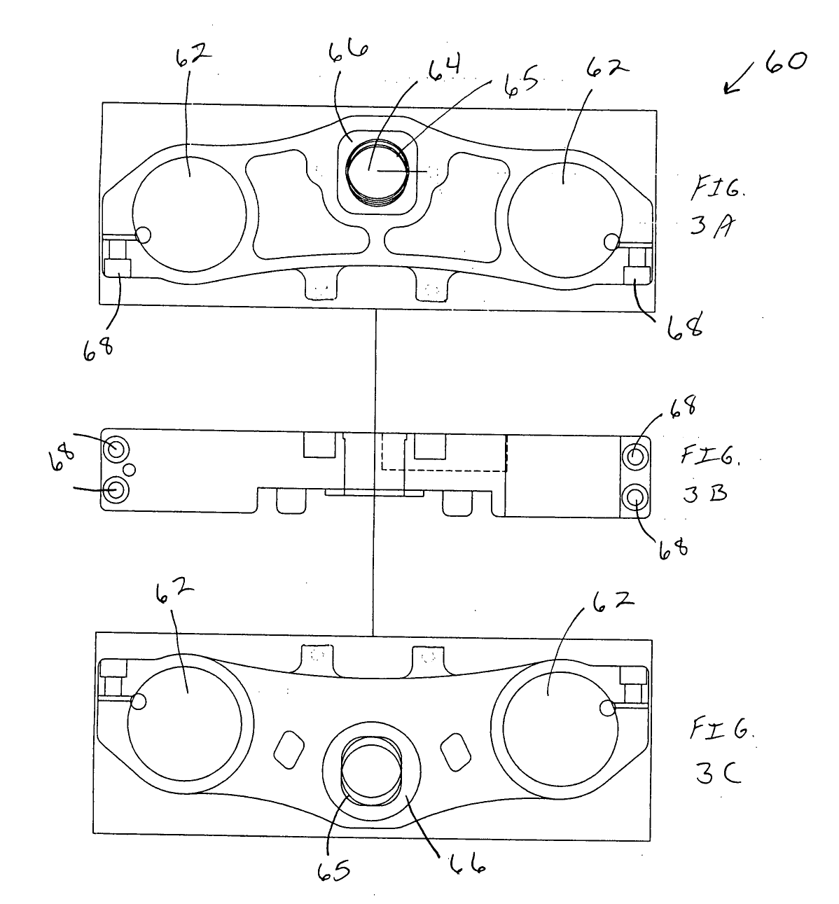

FIGS. 3A-3C show another preferred embodiment of the frame member, preferably used in a lower triple clamp, generally referred to as frame member 60. Frame member 60 is provided with two fork member bores 62 and one steering stem bore 64, each of which must be of sufficient size to allow the fork members (not shown) and the steering stem (not shown) to pass through the bores, respectively. Four bores 68 and corresponding bolts (not shown) are preferably provided to tighten frame member 60 onto the front fork members.

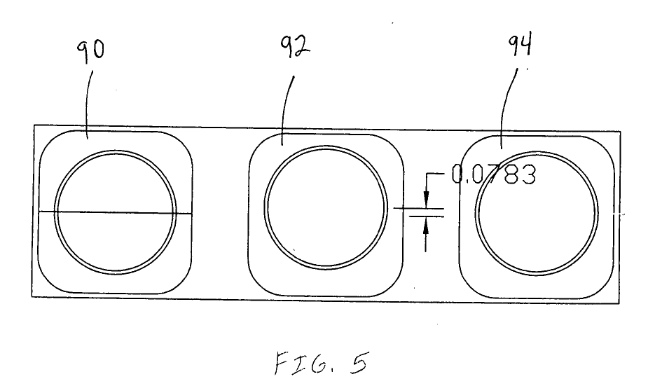

Frame 60 is also provided with a means to selectively change the angle of the steering stem. For example, frame 60 is provided with a steering angle member 66 that is adapted to be inset, and to seat snugly, in steering stem bore 64 before the steering stem is passed through bore 64. Offset bore 65 is provided in steering angle member 66 to adjust the angle of the steering stem (not shown). The user may adjust the angle by repositioning steering angle member 66 into bore 64. Since bore 64 is offset, at least three possible angle positions, as shown in FIG. 5, are available for selection. For example, a first angle is shown as position 90, a second angle is shown as position 92, and a third angle is shown as position 94. The angle selected depends on the orientation of steering angle member 66 when placed in steering stem bore 64. Any number of, and variation on, steering angle member 66 may be interchangeably used with frame 60 and is not limited to the design and shape of steering angle member 66 shown and described in this specification. When seated in the steering stem bore, the outer surface of the inset member is also preferably flush with or below the outer surface of the upper side of the frame member. Steering angle member 66 may be used in a lower frame member in tandem with inset member 20 used in an upper frame member.

FIGS. 6A, 6B, and 6C show another preferred embodiment of the handlebar support member of the invention that comprises a plurality of modular stack members that are adapted to selectively vary the height or vertical position of the handlebar. As shown in FIG. 6, handlebar support member 100 preferably comprises an upper aperture member 102 and a corresponding lower aperture member 104, each part having a semi-annular edge that, when the two parts are fitted together, form an annular aperture 111 through which the handlebar (not shown) is secured. Handlebar support member 100 also comprises base member 106 and a plurality of removable modular stack members 108. Modular stack members 108 preferably have the same outside cross-sectional shape as lower aperture member 104 and base member 106 shown in FIG. 6A and 6B respectively, and have bolt bore. The number of modular stack members used is selectable based on the preferred height of the handlebars. The handlebar height may be adjusted simply by adding or substracting modular stack members. The modular stack members are then stacked between lower aperture member 104 and base member 106. The more modular stack members used, the higher the height of the handlebars, and vice versa. Similar to handlebar support member 40, handlebar support member 100 is then placed on the upper side of frame 10 and bolts 47 are passed through bolt bores 110 provided through both halves of the handlebar support member. The number of modular stack members preferably will determine the length bolts 47.

A preferred embodiment of the adjustable steering system of the invention utilizes an upper triple clamp and a lower triple clamp with which frames 10 and 60 are used, respectively. However, the steering system of the invention need not necessarily utilize all the features of both upper and lower triple clamps described in this specification. For example, if the user only desires to adjust the angle of the steering stem, then both the upper and lower triple clamps may include interchangeable steering angle members, but not include frame engaging parts that are adapted to engage, at selectable horizontal positions, one or more handlebar support engaging parts; or modular stack member that are adapted to raise or lower the vertical position of the handlebar. As another example, if the user only desires to adjust the vertical and horizontal position of the handlebars, then the upper triple clamp may include the engaging parts and modular stack members that allow the user to adjust the position of the handlebars without utilizing any steering angle members. As yet another example, the modular stack members may also be used with or without the steering angle members or the frame engaging parts that are adapted change the horizontal position of the handlebar.

Although specific features of the invention are shown in some drawings and not others, this is for convenience only as some feature may be combined with any or all of the other features in accordance with the invention.

Other embodiments will occur to those skilled in the art and are within the following claims:

1. A triple clamp adapted for use with a vehicle having a steering stem, one or more fork members, and one or more handlebars, comprising,
a frame member having a perimeter that comprises a front edge and a back edge and having a centerline between said front edge and said back edge, comprising,
one or more fork member bores adapted to receive said fork member,
one or more steering stem bores adapted to receive said steering stem;
one or more handlebar support members adapted to support said handlebar; and
one or more means to selectively maintain said handlebar support member in one or more selectable positions;
wherein, said frame member has one or more frame engaging parts that are adapted to engage, at said selectable positions, one or more handlebar support engaging parts provided on said handlebar support member, and wherein at least two of said selectable positions are between said front edge and said centerline, and at least two of said selectable positions are between said back edge and said centerline.

2. The triple clamp of claim 1, wherein at least one of said means to selectively maintain said handlebar support member comprises,
two or more bolts that are each adapted to pass through bolt bores provided in said handlebar support member and said frame member.

3. The triple clamp of claim 2, wherein said frame member has an underside with an outer surface and further comprises a recess in said underside into which at least a portion of said bolts is adapted to protrude from said bolt bores and to engage one or more corresponding stabilizing members having an outer surface that is flush with or within said recess below said outer surface of said frame member.

4. The triple clamp of claim 3, wherein said bolts have threads and wherein said stabilizing member comprises two or more threaded bores corresponding to threads on said bolts.

5. The triple clamp of claim 1, wherein said handlebar support members have a perimeter which remains within said perimeter of said frame member when said handlebar support members are positioned at any one or more of said selectable positions.

6. The triple clamp of claim 1, further comprises one or more position indicators.

7. A triple clamp adapted for use with a vehicle having a steering stem, one or more fork members, and one or more handlebars, comprising,
a frame member, comprising,
one or more fork member bores adapted to receive fork member,
one or more steering stem bores adapted to receive said steering stem;
one or more handlebar support members adapted to support said handlebar; and
one or more means, to selectively maintain said handlebar support member in one or more of said selectable positions, comprising, two or more bolts each adapted to pass through bolt bores provided in said handlebar support member and said frame member;
wherein, said frame member has one or more frame engaging parts adapted to engage, at selectable positions, one or more handlebar support engaging parts provided on said handlebar support member.

8. The triple clamp of claim 7, wherein said frame member has an underside with an outer surface and further comprises a recess in said underside into which at least a portion of said bolts are adapted to protrude from said bolt bores and to engage one or more corresponding stabilizing members having an outer surface that is flush with or within said recess below said outer surface of said frame member.

9. The triple clamp of claim 7, further comprising one or more position indicators.

10. A triple clamp adapted for use with a vehicle having a steering stem, steering stem angle, and one or more fork members, comprising,
a frame member comprising,
one or more fork member bores adapted to receive said fork member,
one or more steering stem bores adapted to receive said steering stem; and
one or more means to selectively change said angle of said steering stem.

11. The triple clamp of claim 10, wherein one or more of said means to selectively change said angle of said steering stem comprises, a steering angle member, having an offset bore through said inset member adapted to receive said steering stem, that is adapted to be removably fixed in said steering stem bore.

12. The triple clamp of claim 11, wherein said steering angle member is adapted to provide two or more selectable steering stem angles.

13. The triple clamp of claim 11, wherein said steering angle member is adapted to be removably inset in said steering stem.

14. The triple clamp of claim 11, wherein said frame member has an outer surface and wherein said steering angle member has an outer surface that, while the steering angle member is inset in said steering stem bore, is flush with or within said steering stem bore below said outer surface of said frame member.

15. The triple clamp of claim 11, wherein said vehicle further comprises one or more handlebars, further comprising,
one or more handlebar support members adapted to support said handlebar; and
one or more means to selectively maintain said handlebar support member in one or more selectable positions.

16. The triple clamp of claim 15, wherein one or more of said means to selectively maintain said handlebar support member comprises; one or more frame engaging parts that are adapted to engage, at said selectable positions, one or more handlebar support engaging parts provided on said handlebar support member.

17. An adjustable steering system adapted for use with a vehicle having a steering stem, a steering stem angle, one or more fork members, and one or more handlebars, comprising,
an upper triple clamp comprising,
a first frame member comprising,
one or more fork member bores adapted to receive said fork member,
one or more steering stem bores adapted to receive said steering stem;
one or more handlebar support members adapted to support said handlebar; and
one or more means to selectively maintain said handlebar support member in one or more selectable positions,
wherein, said frame member has one or more frame engaging parts that are adapted to engage, at said selectable positions, one or more handlebar support engaging parts provided on said handlebar support member; and
a lower triple clamp comprising,
a second frame member comprising,
one or more fork member bores adapted to receive said fork member,
one or more steering stem bores adapted to receive said steering stem;
one or more means to selectively change said angle of said steering stem.

18. The adjustable steering system of claim 17, wherein one or more of said means to selectively change said angle of said steering stem comprises, a steering angle member, having an offset bore through said steering angle member adapted to receive said steering stem, that is adapted to be removably fixed in said steering stem bore of said second frame member.

19. The adjustable steering system of claim 17, wherein said frame member has a front edge, a back edge and a centerline between said front edge and said back edge, and wherein at least two of said selectable positions are between said front edge and said centerline, and at least two of said selectable positions are between said back edge and said centerline.

20. The adjustable steering system of claim 17, wherein said first frame member of said upper triple clamp further comprises one or more means to selectively change said angle of said steering stem.

21. The adjustable steering system of claim 20, wherein one or more of said means, of said first frame member, to selectively change said angle of said steering stem comprises, a steering angle member, having an offset bore through said steering angle member adapted to receive said steering stem, that is adapted to be removably fixed in said steering stem bore of said second frame member.

22. The adjustable steering system of claim 17, wherein at least one of said means to selectively maintain said handlebar support member comprises two or more bolts that are each adapted to pass through bolt bores provided in said handlebar support member and said frame member; and wherein said frame member has an underside with an outer surface and further comprises a recess in said underside into which at least a portion of said bolts is adapted to protrude from said bolt bores and to engage one or more corresponding stabilizing members having an outer surface that is flush with or within said recess below said outer surface of said frame member.

23. An adjustable steering system adapted for use with a vehicle having a steering stem, a steering stem angle, one or more fork members, and one or more handlebars, comprising,
an upper triple clamp comprising,
a first frame member comprising,
one or more first fork member bores adapted to receive said fork member,
one or more first steering stem bores adapted to receive said steering stem;
one or more handlebar support members adapted to support said handlebar; and
one or more means to selectively maintain said handlebar support member in one or more selectable positions,
wherein, said frame member has one or more frame engaging parts that are adapted to engage, at said selectable positions, one or more handlebar support engaging parts provided on said handlebar support member; and
one or more first means to selectively change said angle of said steering stem; and
a lower triple clamp comprising,
a second frame member comprising,
one or more second fork member bores adapted to receive said fork member,
one or more second steering stem bores adapted to receive said steering stem;
one or more second means to selectively change said angle of said steering stem.

24. The adjustable steering system of claim 23, wherein one or more of said first means or said second means, to selectively change said angle of said steering stem, comprises, a steering angle member, having an offset bore through said steering angle member that is adapted to receive said steering stem, that is adapted to be removably fixed in said first or second steering stem bore, respectively.

25. An adjustable steering system adapted for use with a vehicle having a steering stem, a steering stem angle, one or more fork members, and one or more handlebars, comprising,
an upper triple clamp comprising,
a first frame member comprising,
one or more first fork member bores adapted to receive said fork member,
one or more first steering stem bores adapted to receive said steering stem;
one or more handlebar support members adapted to support said handlebar; and
one or more means to selectively maintain said handlebar support member in one or more selectable positions,
wherein, said frame member has one or more frame engaging parts that are adapted to engage, at said selectable positions, one or more handlebar support engaging parts provided on said handlebar support member; and
one or more first means to selectively change said angle of said steering stem; and a lower triple clamp comprising,
a second frame member comprising,
one or more second fork member bores adapted to receive said fork member,
one or more second steering stem bores adapted to receive said steering stem;
one or more second means to selectively change said angle of said steering stem.

26. A triple clamp that is adapted for use with a vehicle having a steering stem, one or more fork members, and one or more handlebars set at a height, comprising,
a frame member comprising,
one or more fork member bores adapted to receive said fork member,
one or more steering stem bores adapted to receive said steering stem;
one or more handlebar support members adapted to support said handlebar; and
one or more means to selectively maintain said handlebar support member in one or more selectable positions;
wherein said handlebar support member comprises one or more modular stack members that are adapted to selectively vary said height of said handlebar.

27. An adjustable steering system that is adapted for use with a vehicle having a steering stem, a steering stem angle, one or more fork members, and one or more handlebars, comprising,
an upper triple clamp comprising,
a first frame member comprising,
one or more first fork member bores adapted to receive said fork member,
one or more first steering stem bores adapted to receive said steering stem;
one or more handlebar support members adapted to support said handlebar; and
one or more means to selectively maintain said handlebar support member in one or more selectable positions,
wherein, said first frame member has one or more frame engaging parts that are adapted to engage, at said selectable positions, one or more handlebar support engaging parts provided on said handlebar support member; and
one or more first means to selectively change said angle of said steering stem; and
a lower triple clamp comprising,
a second frame member comprising,
one or more second fork member bores adapted to receive said fork member,
one or more second steering stem bores adapted to receive said steering stem; and
one or more means to selectively change said angle of said steering stem; and
wherein said handlebar support member comprises one or more modular stack members that are adapted to selectively vary said height of said handlebar.

28. A steering angle device, adapted for use with a triple clamp of a vehicle having a steering stem and a steering stem angle, wherein said triple clamp has one or more steering stem bores adapted to receive said steering stem at an angle relative to said triple clamp and one or more steering angle apertures; said steering angle device comprising,
a steering angle frame having a perimeter with two perimeter points located on said perimeter opposite from one another, and a frame centerpoint that is equidistant from said two opposite perimeter points, wherein said steering angle frame has a bore, that is adapted to receive said steering stem through said bore, wherein said bore has a bore centerpoint that is offset from said frame centerpoint, and wherein at least a portion of said steering angle frame is adapted to be removably fixed in said steering angle aperture.
